(19) United States
(12) Patent Application Publication
(10) Pub. No.: US 2007/0225018 A1
(43) Pub. Date: Sep. 27, 2007

(54) Bluetooth mobile device and a calling method thereof

(75) Inventor: Min-Won Cho, Seongnam-si (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/715,994

(22) Filed: Mar. 9, 2007

(30) Foreign Application Priority Data
Mar. 9, 2006 (KR) 2006-0022153

(51) Int. Cl. H04Q 7/20

(52) U.S. Cl. 455/456.1

(57) ABSTRACT

Provided are a Bluetooth mobile device and a calling method thereof. The calling method of the Bluetooth mobile device includes when a called/calling history confirmation key is pressed, receiving a recent called/calling history from a mobile communication terminal to display the recent called/calling history; and when a call key is pressed, transmitting phone number data of a selected item of the displayed recent called/calling history to the mobile communication terminal to request the mobile communication terminal to make a call.

### PRIORITY

This application claims priority under 35 U.S.C. §119 to an application filed in the Korean Intellectual Property Office on Mar. 9, 2006 and assigned Serial No. 2006-22153, the contents of which are incorporated herein by reference.

### BACKGROUND OF THE INVENTION

1. Field of the Invention

The present invention relates generally to a Bluetooth® (Bluetooth) mobile device and a calling method thereof, and in particular, to Bluetooth mobile device and method for making a call using a recent called/calling history and a phone book of a mobile communication terminal.

2. Description of the Related Art

With the development of electronic and communication industries, mobile terminals are widely used and functions of mobile terminals are diversified to satisfy a user's demands.

In addition to a simple communication function, the mobile terminals provide a variety of additional functions including downloading music files to enjoy music, downloading Video On Demand (VOD) files to enjoy moving images, and photographing objects to store the photographed images in an album. Moreover, a variety of peripheral devices attached to the mobile terminals are also developed. Examples of these peripheral devices include detachable or built-in digital cameras, Digital Multimedia Broadcasting (DMB) receivers capable of receiving over-the-air broadcasting, and Bluetooth headset devices capable of hands-free communication through Bluetooth communication between terminals and Bluetooth mobile devices.

Bluetooth mobile devices wirelessly connect to digital devices in a small size, low cost, and low power consumption manner. Therefore, in recent years, Bluetooth mobile devices have become widely used in a variety of fields. Although the Bluetooth mobile devices are mainly used for hands-free communication, mobile communication terminals provide a variety of additional functions (e.g., MP3 player function) in order to meet a user's demands.

Bluetooth mobile devices can communicate with a mobile communication terminal that is separated, to some extent (10˜100 m), a predetermined distance from the mobile communication terminal. Accordingly, a user's convenience can be increased when some of the functions of the mobile communication terminal can be used through the Bluetooth mobile devices even without direct manipulation of the mobile communication terminal. For example, when a phone book of the mobile communication terminal can be searched for at the Bluetooth mobile device, the user can make a call to a target phone number even without direct manipulation of the remotely located mobile communication terminal.

### SUMMARY OF THE INVENTION

An object of the present invention is to substantially solve at least the above described problems and/or disadvantages and to provide at least the advantages described below. Accordingly, an object of the present invention is to provide a Bluetooth mobile device and a calling method thereof.

Another object of the present invention is to provide a Bluetooth mobile device and a method for accessing a recent called/calling history of a mobile communication terminal to make a call in the Bluetooth mobile device.

A further object of the present invention is to provide a Bluetooth mobile device and a method for receiving a phone book of a mobile communication terminal in the Bluetooth mobile device.

Still another object of the present invention is to provide a Bluetooth mobile device and a method for making a call using a phone book received from a mobile communication terminal in the Bluetooth mobile device.

Yet another object of the present invention is to provide a Bluetooth mobile device and a method for making a call using a software keypad displayed on a display window in the Bluetooth mobile device.

According to an aspect of the present invention, there is provided a calling method of a Bluetooth mobile device. The method includes when a called/calling history confirmation key is pressed, receiving a recent called/calling history from a mobile communication terminal to display the recent called/calling history; and when a call key is pressed, transmitting phone number data of a selected item of the displayed recent called/calling history to the mobile communication terminal to request the mobile communication terminal to make a call.

According to another aspect of the present invention, there is provided a calling method of a Bluetooth mobile device. The method includes when a phone book reception key is pressed, receiving phone book data from a mobile communication terminal; and storing the received phone book data in a memory; when a phone book search key is pressed, displaying a phone number list of the stored phone book; and when a call key is pressed, transmitting phone number data of a selected item of the displayed phone book list to the mobile communication terminal to request the mobile communication terminal to make a call.

According to a further aspect of the present invention, there is provided a calling method of a Bluetooth mobile device. The method includes when a communication request key is pressed, displaying a virtual keypad on a display unit; pressing numerical keys of the displayed virtual keypad; buffering numbers corresponding to the pressed keys; and when a calling key is pressed, transmitting the buffered number data to a mobile communication terminal to request the mobile communication terminal to make a call.

### BRIEF DESCRIPTION OF THE DRAWINGS

The above and other objects, features, and advantages of the present invention will become more apparent from the following detailed description when taken in conjunction with the accompanying drawings in which:

FIG. 1 is a perspective view illustrating a mobile communication terminal and a Bluetooth mobile device performing a near field communication according to the present invention;

FIG. 2 is a block diagram illustrating a Bluetooth mobile device according to the present invention;

FIG. 3 is a flowchart illustrating a process for accessing, at a Bluetooth mobile device, a recent called/calling history of a mobile communication terminal and making a call according to the present invention;

FIG. 4 is a flowchart illustrating a process for receiving, at a Bluetooth mobile device, a phone book of a mobile communication terminal according to the present invention;

FIG. 5 is a flowchart illustrating a process for making a call, at a Bluetooth mobile device, using a phone book of a mobile communication terminal according to the present invention;

FIG. 6 is a flowchart illustrating a process for receiving, at a Bluetooth mobile device, a phone number and making a call according to the present invention; and

FIGS. 7 to 10 are views of a screen according to the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail because they would obscure the present invention in unnecessary detail.

Hereinafter, a method for utilizing a function of a mobile communication terminal through a Bluetooth mobile device, and in particular, a method for utilizing, at a Bluetooth mobile device, a recent call/calling history and a phone book of a mobile communication terminal according to the present invention will be described in detail herein.

An example of the Bluetooth mobile device cooperating with the mobile communication terminal includes a Bluetooth headset as described above. In the following description, a mobile device that integrates a MP3 (MPEG audio layer-3) player with a Bluetooth module (hereinafter, Bluetooth MP3 player) will be described as an example.

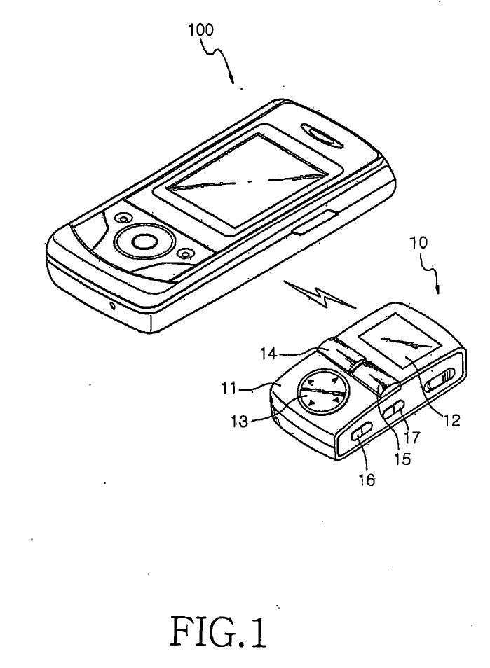

FIG. 1 is a perspective view of a mobile communication terminal 100 and a Bluetooth mobile device 10 performing a near field communication with each other according to present invention.

Although the Bluetooth MP3 player will be illustrated as an example, the Bluetooth mobile device according to the present invention has application to another mobile devices that enable Bluetooth communication.

Referring to FIG. 1, the Bluetooth MP3 player 10 includes a display unit 12 having a predetermined area on a body 11 having a predetermined shape and size. A plurality of keys 13, 14, 15, 16, and 17 are installed on appropriate positions of the body 11 to perform their functions. Examples of the keys installed on a lower surface include a key 14 that serves as a Call/Cancel (delete) key, a key 15 that serves as a Menu/Confirmation key, and Navigation keys 13 for menu search/music search/volume control. Examples of the keys' installed on a lateral surface include a power on/off key 16, a Bluetooth on/off key 17. Although not shown, a variety of keys such as a hold key may be additionally installed.

Also, an ear jack terminal (not shown) is installed in an appropriate position on the body 11 of the Bluetooth MP3 player 10 to electrically connect with a predetermined earphone device (not shown). Furthermore, when a user makes a call by performing a near field communication with the mobile communication terminal 100, a microphone device installed in an appropriate position of the body 11 of the Bluetooth MP3 player 10 may be used as voice communication means.

The Bluetooth MP3 player 10 performs the near field communication with the mobile communication terminal 100 besides a basic MP3 player function. According to the present invention, data and a recent called/calling history stored in a phone book of a mobile communication terminal 100 are received to the Bluetooth MP3 player 10 and displayed on the display unit 12. Therefore, the user may search for a desired phone number and make a call by selecting the desired number. Preferably, the user may use the Navigation keys 13 in order to select the desired phone number among phone book contents displayed on the display unit 12. However, the present invention should not be construed as being limited to use of the Navigation keys 13. For example, the user may scroll the display unit 12 having a touch screen function in order to directly search for other data. A detailed operation according to the present invention will be described with reference to the accompanying drawings.

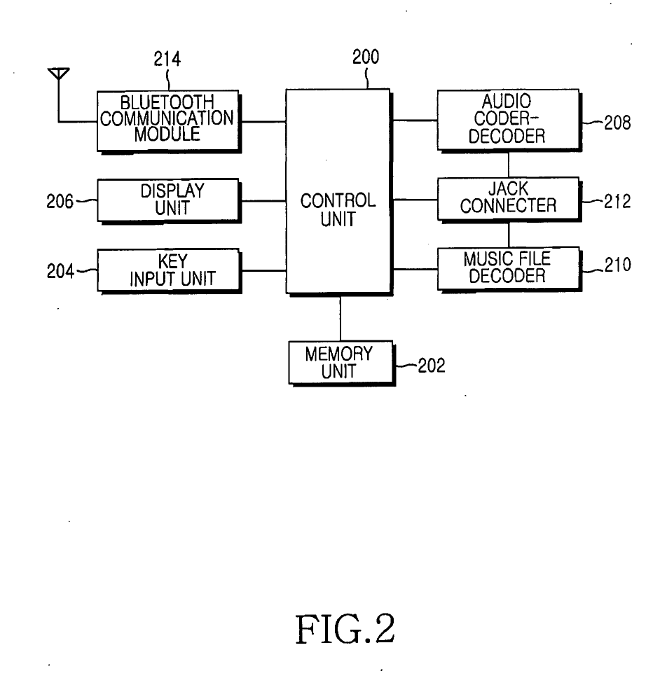

FIG. 2 is a block diagram illustrating a Bluetooth mobile device 10 according to the present invention.

Referring to FIG. 2, the Bluetooth mobile device 10 includes a control unit (e.g., a MicroProcessor Unit (MPU)) 200, a memory unit 202, a key input unit 204, a display unit 206, an audio Coder-Decoder (CODEC) 208, a music file decoder 210, a jack connector 212, and a Bluetooth communication module 214.

The control unit 200 controls an overall operation of the Bluetooth mobile device 10. For example, the control unit 200 processes and controls communication between the Bluetooth mobile device 10 and the mobile communication terminal 100 and controls an overall operation related to decoding music files. Also, the control unit 200 receives a recent called/calling history and phone book data from the mobile communication terminal 100, and performs a function for making a call using the data.

The memory unit 202 includes a flash memory, a Random Access Memory (RAM), and a Read Only Memory (ROM). The memory unit 202 stores program data for processing/controlling an overall operation of the Bluetooth mobile device 10, temporary data generated during an operation of the Bluetooth mobile device 10, system parameters, and the music files. The memory unit 202 stores the recent called/calling history and the phone book data received from the mobile communication terminal 100.

The key input unit 204 includes a plurality of keys that can operate the Bluetooth mobile device to provide key input data that corresponds to a key pressed by the user to the control unit 200. The display unit 206 displays status information generated during operations of the Bluetooth mobile device 10, numerals and characters, moving pictures and still pictures, and so on. The display unit 206 may be a color Liquid Crystal Display (LCD) and may be implemented using a touch screen in order to cover the keys of the limited numerals.

The audio CODEC 208 processes a voice signal exchanged with the mobile communication terminal 100. The music file decoder 210 compresses and decompresses the music files (e.g., MP3 file) received from the memory unit 202. The audio CODEC 208 converts digital data into an analog audio signal. The jack connector 212 connects an audio signal decoded by the audio CODEC 208 or an audio signal decoded by the music file decoder 210 to the earphone device installed in the Bluetooth mobile device 10.

The Bluetooth communication module 214 adds a predetermined header to a Host Control Interface (HCI) message from the control unit 200 to generate a packet having a predetermined standard. The packet is converted into Radio-Frequency (RF) signals and the converted RF signals are transmitted via an antenna. Alternatively, the Bluetooth communication module 214 converts the RF signals received from the antenna into baseband signals. The HCI message is extracted from the baseband signals, and the extracted message is provided to the control unit 200. The HCI message (or the packet) is roughly classified into a command packet, an event packet, and a data packet. The command packet allows the Bluetooth communication module to be utilized in various ways.

A calling method in the Bluetooth mobile device 10 according to present invention is divided into three methods. A first method uses a recent called/calling history of the mobile communication terminal 100. A second method uses a phone book of the mobile communication terminal 100. A third method directly receives a phone number from a user to make a call. The three methods will be sequentially described below.

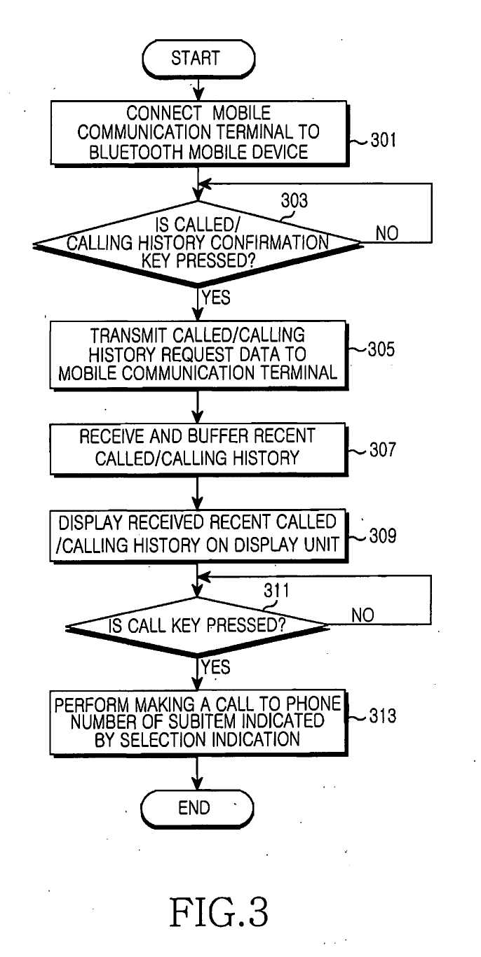

FIG. 3 is a flowchart illustrating a process for accessing a recent called/calling history of a mobile communication terminal and making a call in a Bluetooth mobile device according to the present invention.

Referring to FIG. 3, the control unit 200 connects the mobile communication terminal 100 to the Bluetooth mobile device 10 in responses to a user's manipulation in step 301. With the mobile communication terminal 100 connected to the Bluetooth mobile device 10, the control unit 200 determines whether a called/calling history confirmation key is pressed in step 303.

When the called/calling history confirmation key is pressed, the control unit 200 generates a message requesting the recent called/calling history and sends the requesting message to the mobile communication terminal 100 through the Bluetooth communication module 214 in step 305. That is, the control unit 200 generates a HCI message requesting the called/calling history to send the generated HCI message to the Bluetooth communication module 214. The Bluetooth communication module 214 processes the HCI message in a transmittable form according to a predetermined standard to send the processed message to the mobile communication terminal 100. After sending the called/calling history request message, the control unit 200 receives the recent called/calling history and performs buffering in step 307.

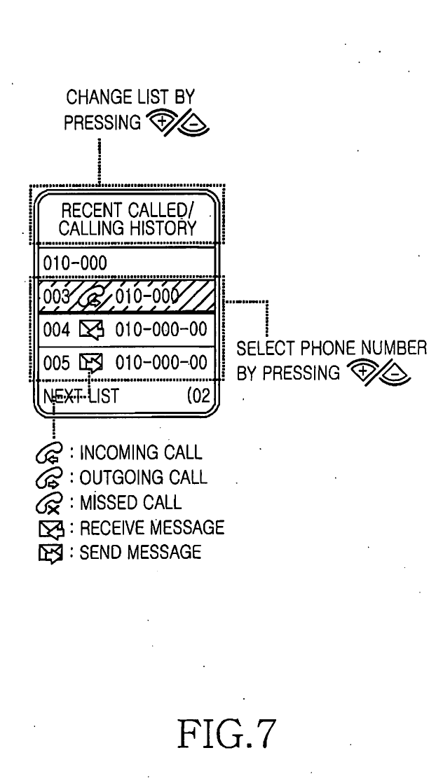

In step 309, the control unit 200 displays the buffered recent called/calling history on the display unit 206. For example, the recent called/calling history may be displayed on the display unit 206′ as illustrated in FIG. 7. At this time, a user can search the recent called/calling history using the Navigation keys 13. Referring to FIG. 7, a history (e.g., incoming call, outgoing call, missed call, receive short message, and send short messages) can be changed using left/right keys among the Navigation keys 13 and a target sub-item can be selected using up/down keys.

Meanwhile, with the recent called/calling history displayed, the control unit 200 determines in step 311 whether a call key is pressed by the user's manipulation. When the call key is pressed, the control unit 200 transmits phone number data of the sub-item indicated by selection indication means to the mobile communication terminal and in step 313 requests making a call. The mobile communication terminal 100 receiving the phone number data from the Bluetooth mobile device 10 makes a call to the received phone number. After making a call, a communication mode is performed by connecting a communication path.

Although not shown in FIG. 3, the Bluetooth mobile device can receive the called/calling history by a predetermined number unit. For example, assuming that the Bluetooth mobile device 10 receives called/calling histories by ten item units, the Bluetooth mobile device 10 receives and displays ten called/calling histories on the first place. After that, the Bluetooth mobile device 10 can request next ten items only when a key operation requiring next histories is performed.

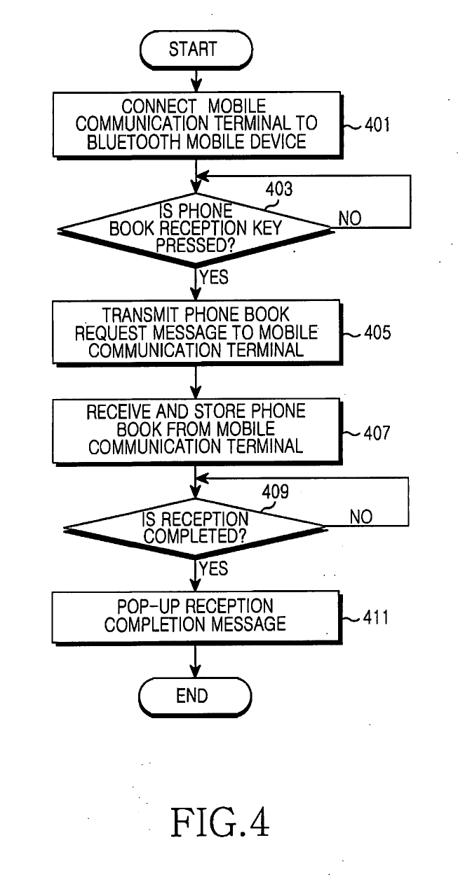

FIG. 4 is a flowchart illustrating a process for receiving a phone book of a mobile communication terminal in a Bluetooth mobile device according to the present invention.

Referring to FIG. 4, in step 401 the control unit 200 connects the mobile communication terminal 100 to the Bluetooth mobile device 10 by user's manipulation. With the mobile communication terminal 100 connected to the Bluetooth mobile device 10, in step 403 the control unit 200 determines whether a phone book reception key is pressed.

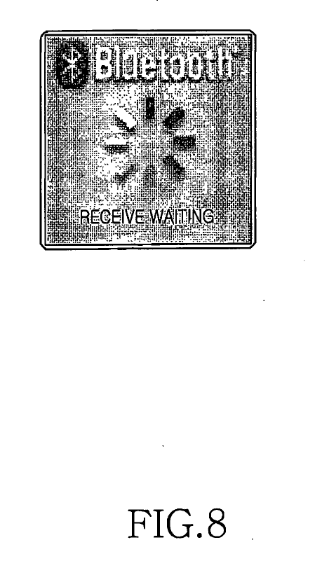

When the phone book reception key is pressed, the control unit 200 generates a message requesting a phone book and sends the phone book request massage to the mobile communication terminal 100 through the Bluetooth mobile device 214 in step 405. After sending the phone book request message, the control unit 200 receives phone book data from the mobile communication terminal 100 and stores the received phone book data in the memory unit 202 in step 407. The control unit 200 may display a present reception state on a screen as illustrated in FIG. 8. FIG. 8 is a view illustrating a state in which a third phone number item is presently received.

In step 409, the control unit 200 determines whether all phone number data are received. In step 411, when reception of the phone number data is completed, the control unit 200 displays a pop-up window with a message “RECEPTION IS COMPLETED” on the display unit 206. Thereafter, the control unit 200 terminates the algorithm.

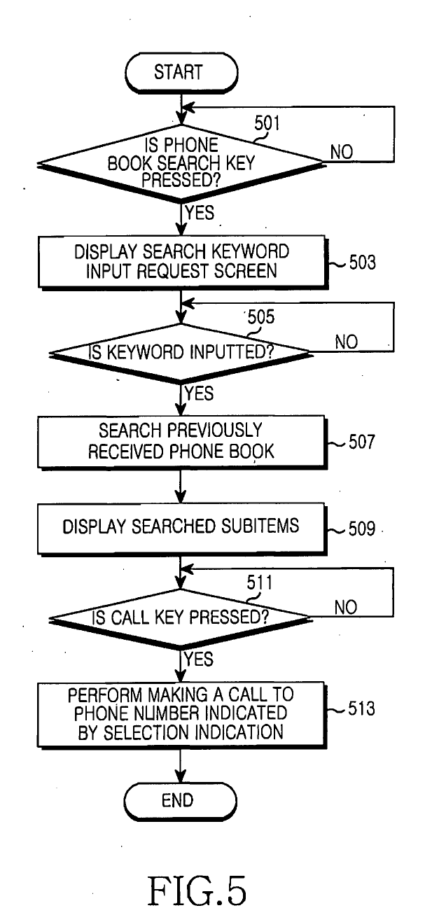

A method of making a call using the received phone book will be described below. FIG. 5 is a flowchart illustrating a process for making a call using a phone book of a mobile communication terminal in a Bluetooth mobile device according to the present invention.

Referring to FIG. 5, the control unit 200 determines whether a phone book search key is pressed in step 501. When the phone book search key is pressed, the control unit 200 displays a keyword input request screen for searching a phone book on the display unit 206 in step 503. As is known, a phone book search keyword may include a name and a number. An example of searching a phone number using an initial letter will be described below.

After displaying the keyword input request screen, in step 505 the control unit 200 determines whether a search keyword is inputted. When the search keyword is inputted, the control unit 200 searches a previously received phone book from the mobile communication terminal 100 with the inputted keyword in step 507.

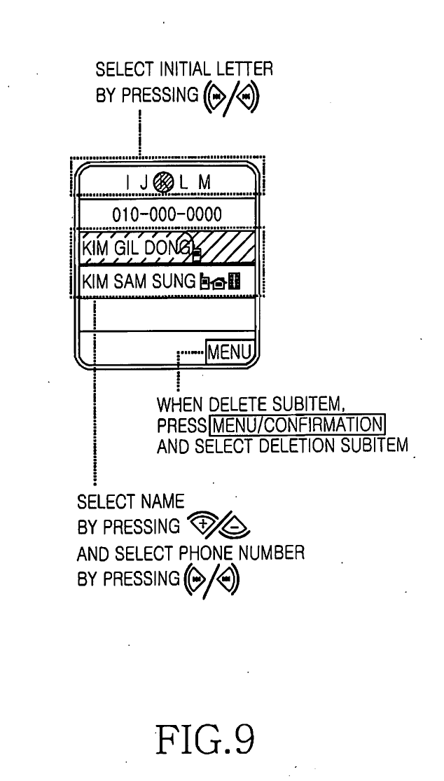

In step 509, the control unit 200 displays items searched from the phone book on the display unit 206. FIG. 9 is a view illustrating an example screen for searching a phone number using an initial letter. Referring to FIG. 9, alphabets are arranged on an upper portion of a screen and a user selects the initial letter of a name to be searched using left/right keys. Whenever the initial letter is selected, phone number items corresponding to each of the initial letters are searched and displayed on a main screen. The user selects a target phone number sub-item using the left/right keys.

In step 511, the control unit 200 determines whether a call key is pressed by a user's manipulation. When the call key is pressed, the control unit 200 transmits phone number data of the item indicated by selection indication means to the mobile communication terminal to request the mobile communication terminal to make a call in step 513. Upon the mobile communication terminal 100 receiving the phone number data from the Bluetooth mobile device 10, it makes a call to the received phone number. After making a call, a communication mode is performed by connecting a communication path.

Although a case searching a phone number by the search keyword is explained in FIG. 5, phone numbers of the previously received phone book are displayed and may make a call by selecting one of the phone numbers when the phone book search key is pressed according to the present invention.

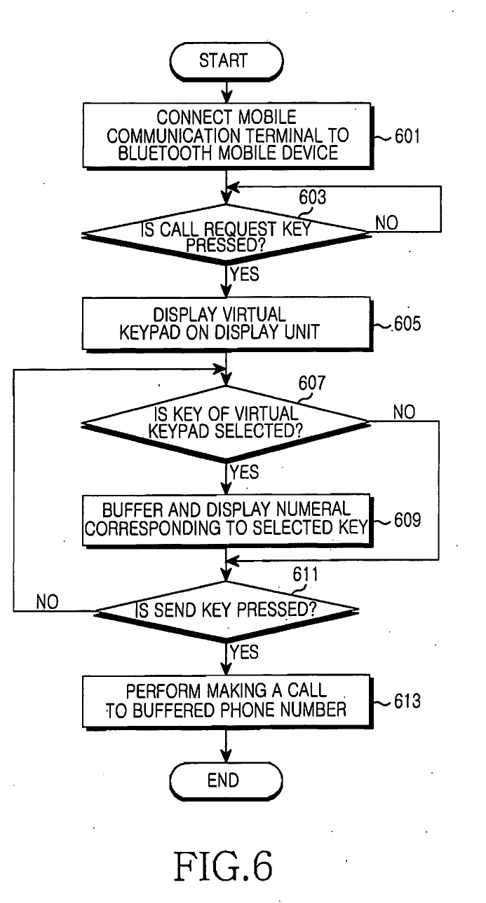

FIG. 6 is a flowchart illustrating a process for receiving a phone number and making a call in a Bluetooth mobile device according to the present invention.

Referring to FIG. 6, the control unit 200 connects the mobile communication terminal 100 to the Bluetooth mobile device 10 by user's manipulation in step 601. With the mobile communication terminal 100 connected to the Bluetooth mobile device 10, in step 603 the control unit 200 determines whether a call request key is pressed.

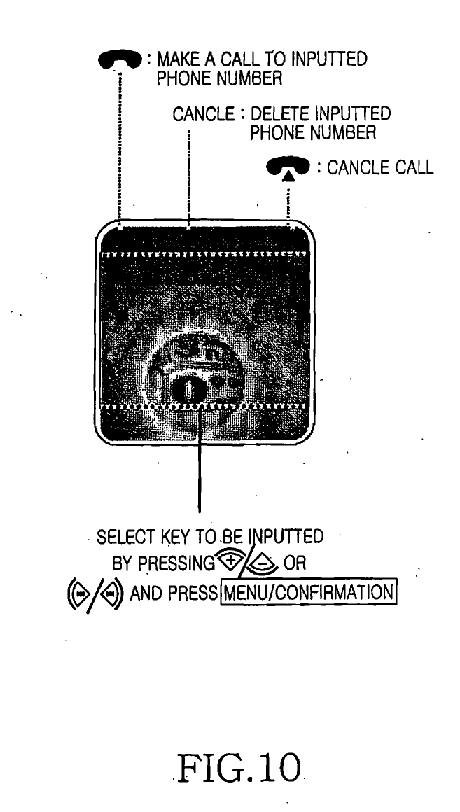

When the call request key is pressed, the control unit 200 displays a virtual keypad inputting a phone number in step 605. The virtual keypad may have an identical shape with a normal mobile communication terminal. For example, the virtual keypad is displayed to a 4×3 key matrix as illustrated in FIG. 10. A user manipulates Navigation keys and moves a selection indication (enlarged indication) to a target key. Thereafter, the user presses a confirmation key to select other key.

In step 607, the control unit 200 determines whether a key of the virtual keypad is selected by the user's manipulation. When the key is selected, the control unit 200 buffers a numeral (or number) corresponding to the selected key and displays the numeral (or number) on an appropriate position in step 609. Thereafter, in step 611 the control unit 200 determines whether a send key is pressed by the user's manipulation.

When the send key is not pressed, the process returns to step 607 in order to continuously receive numbers. In step 613 when the send key is pressed, the control unit 200 transmits the buffered number data to the mobile communication terminal and requests making a call. Upon the mobile communication terminal 100 receiving of the phone number data from the Bluetooth mobile device 10, it makes a call to the received phone number.

Although not shown in FIG. 6, the user may input a phone number by touching numerals displayed on the display unit 206 using fingers or a stylus pen.

As described above, the present invention makes a call using a variety of methods through the Bluetooth mobile device even without direct manipulation of the mobile communication terminal 100. Accordingly, it is possible to increase user's convenience. Especially, the phone book and the called/calling history are confirmed in the Bluetooth mobile device. Therefore, the present invention makes it convenient for the user to make a call to a target phone number even without direct manipulation of the mobile communication terminal 100 located in remote sites.

While the present invention has been shown and described with reference to certain preferred embodiments thereof, it will be understood by those skilled in the art that various changes in form and details may be made therein without departing from the spirit and scope of the present invention as defined by the appended claims.

What is claimed is:

1. A calling method of a Bluetooth mobile device, comprising the step of:
when a called/calling history confirmation key is pressed, receiving a recent called/calling history from a mobile communication terminal to display the recent called/calling history; and
when a call key is pressed, transmitting phone number data of a selected item of the displayed recent called/calling history to the mobile communication terminal to request the mobile communication terminal to make a call.

2. The method of claim 1, wherein receiving the recent called/calling history comprises:
receiving a predetermined number of called/calling histories from the mobile communication terminal to display the received called/calling histories; and
when a key requesting a next called/calling histories is pressed, receiving a predetermined number of the next called/calling histories to display the next called/calling histories.

3. The method of claim 1, wherein transmitting phone number data of a selected item of the displayed recent called/calling history comprises:
moving a selection indication to one subitem on the recent called/calling history by manipulating navigation keys; and
when the call key is pressed, transmitting phone number data of a sub-item indicated by the selection indication to the mobile communication terminal to request the mobile communication terminal to make a call.

4. A calling method of a Bluetooth mobile device, comprising the steps of:
when a phone book reception key is pressed, receiving phone book data from a mobile communication terminal; and
storing the received phone book data in a memory.

5. The method of claim 4, further comprising displaying a present reception state of the phone book data.

6. The method of claim 4, further comprising:
when a phone book search key is pressed, displaying a phone number list of the stored phone book; and
when a call key is pressed, transmitting phone number data of a selected item of the displayed phone number list to the mobile communication terminal to request the mobile communication terminal to make a call.

7. The method of claim 4, further comprising:
when a phone book search key is pressed, displaying a search keyword request screen;
when a search keyword is input, searching the stored phone book data using the keyword and displaying phone number items of the searched phone book data; and
when a call key is pressed, transmitting a phone number of an item selected from the searched phone book data to the mobile communication terminal to request the mobile communication terminal to make a call.

8. A calling method of a Bluetooth mobile device, comprising the steps of:
when a call request key is pressed, displaying a virtual keypad on a display unit;
pressing numerical keys of the displayed keypad;
buffering numbers corresponding to the pressed keys; and
when a calling key is pressed, transmitting the buffered numbers to a mobile communication terminal to request the mobile communication terminal to make a call.

9. The method of claim 8, wherein the virtual keypad includes a 4×3 key matrix.

10. The method of claim 8, wherein the pressing step comprises:
moving a selection indication to one of the keys of the keypad by manipulating navigation keys; and
when a confirmation key is pressed, inputting a key indicated by the selection indication.

11. The method of claim 8, wherein the pressing step comprises:
detecting screen touching; and
inputting a key displayed on the touched position.

12. A Bluetooth mobile device comprising:
a Bluetooth communication module for performing Bluetooth communication with a mobile communication terminal;
a control unit for requesting the mobile communication terminal to transmit a recent called/calling history through the Bluetooth communication module and receiving the recent called/calling history from the mobile communication terminal through the Bluetooth communication module when a called/calling history confirmation key is pressed; and
a display unit for displaying the recent called/calling history under control of the control unit,
wherein the control unit transmits phone number data of a selected item of the displayed recent called/calling history to the mobile communication terminal through the Bluetooth communication module when a call key is pressed.

13. A Bluetooth mobile device comprising:
a Bluetooth communication module for performing Bluetooth communication with a mobile communication terminal;
a control unit for requesting the mobile communication terminal to transmit phone book data through the Bluetooth communication module and receiving phone book data from the mobile communication terminal through the Bluetooth communication module when a phone book reception key is pressed; and
a memory unit for storing the phone book data under control of the control unit.

14. The device of claim 13, further comprising a display unit for displaying the stored phone book data when a phone book search key is pressed,
wherein the control unit transmits phone number data of a selected item of the displayed phone book to the mobile communication terminal through the Bluetooth communication module when a call key is pressed.

15. A Bluetooth mobile device comprising:
a Bluetooth communication module for performing Bluetooth communication with a mobile communication terminal;
a display unit for displaying a virtual keypad when a call request key is input;
a control unit for buffering numbers corresponding to selected keys when the keys of the keypad are selected, and transmitting the buffered numbers to the mobile communication terminal through the Bluetooth communication module to request the mobile communication terminal to make a call when a call key is pressed.

16. The device of claim 15, wherein the keys of the keypad are selected by manipulating navigation keys.

17. The device of claim 15, wherein the keys of the keypad are selected by touching a screen.

18. A calling method of a Bluetooth mobile device, comprising the step of:
receiving a recent called/calling history from a mobile communication terminal; and
transmitting phone number data of a selected item of the recent called/calling history to the mobile communication terminal.

19. A calling method of a Bluetooth mobile device, comprising the steps of:
displaying a virtual keypad on a display unit;
sensing numerical keys of the displayed keypad;
transmitting the sensed numbers to a mobile communication terminal to request the mobile communication terminal to make a call.

20. A Bluetooth mobile device comprising:
means for displaying a virtual keypad on a display unit;
means for sensing numerical keys of the displayed keypad;
means for transmitting the sensed numbers to a mobile communication terminal to request the mobile communication terminal to make a call.
